(19) United States
(12) Patent Application Publication
(10) Pub. No.: US 2022/0026853 A1
(43) Pub. Date: Jan. 27, 2022

(54) MOBILE DEVICE

(71) Applicant: CITIZEN WATCH CO., LTD., Tokyo (JP)

(72) Inventors: Masato TAKAHASHI, Tokorozawa-shi, Saitama (JP); Toshinari MAEDA, Tokorozawa-shi, Saitama (JP); Makoto WATANABE, Tokorozawa-shi, Saitama (JP); Yudai HOSHI, Shinagawa-ku, Tokyo (JP)

(21) Appl. No.: 17/297,429

(22) PCT Filed: Oct. 18, 2019
(86) PCT No.: PCT/JP2019/041122

§ 371 Date: May 26, 2021

(30) Foreign Application Priority Data
Nov. 29, 2018 (JP) 2018-223381

(51) Int. Cl. G04B 37/02; H02N 1/08; G04C 10/00; G04G 19/02

(52) U.S. Cl. CPC G04B 37/02; H02N 1/08; H02N 2/00; G04G 19/02; G04C 10/00

(57) ABSTRACT

Provided is a wristwatch, including: an exterior case including a back cover; a moisture absorbent sheet to be provided on an inner surface of the back cover; and a holding sheet configured to adhere to the inner surface of the back cover around the moisture absorbent sheet and cover an edge of the moisture absorbent sheet, to thereby hold the moisture absorbent sheet such that the moisture absorbent sheet is allowed to absorb moisture.

### TECHNICAL FIELD

The present invention relates to a mobile device.

### BACKGROUND ART

In Patent Literature 1, there is disclosed a watch in which an anti-fog sheet is provided to adhere to a back cover. In Patent Literature 1, a double-sided adhesive tape is bonded to a back side of the anti-fog sheet so that the anti-fog sheet is held on the back cover. As described above, with the anti-fog sheet being accommodated in the watch, increase in humidity inside the watch is suppressed to suppress fogging of a cover glass.

### CITATION LIST

### Patent Literature

[Patent Literature 1] JP S56-84341 A

### SUMMARY OF INVENTION

### Technical Problem

In this case, the anti-fog sheet (moisture absorbent sheet) absorbs moisture to expand, and deforms in shape. In the configuration disclosed in Patent Literature 1, the double-sided adhesive tape may not be able to follow the change in shape caused by the expansion of the anti-fog sheet, and thus an edge of the anti-fog sheet may come off. When the edge of the anti-fog sheet comes off to peel off from the back cover, the anti-fog sheet may not be able to exert its original moisture absorbing function.

The present invention has been made in view of the above-mentioned problem, and has an object to keep a moderate humidity inside a device.

### Solution to Problem

In order to solve the above-mentioned problem, the invention disclosed in the subject application has various aspects, and a summary of a representative one of those aspects is as follows.

(1) A mobile device, including: an exterior case including a back cover; a moisture absorbent sheet to be provided on an inner surface of the back cover; and a holding sheet configured to at least adhere to the inner surface of the back cover around the moisture absorbent sheet and cover an edge of the moisture absorbent sheet, to thereby hold the moisture absorbent sheet such that the moisture absorbent sheet is allowed to absorb moisture.

(2) The mobile device according to Item (1), further including a motive power mechanism to be accommodated in the exterior case, wherein the back cover has conductivity, wherein the holding sheet has conductivity, and wherein the motive power mechanism and the back cover are conducted via a conducting member extending from the motive power mechanism to be in contact with the holding sheet.

(3) The mobile device according to Item (1), further including a motive power mechanism to be accommodated in the exterior case, wherein the back cover has conductivity, wherein the holding sheet has a cutout or a hole for exposing a part of the inner surface of the back cover, wherein the motive power mechanism and the back cover are conducted via a conductive member extending from the motive power mechanism to be in contact with a region of the inner surface of the back cover, which is exposed from the cutout or the hole.

(4) The mobile device according to Item (3), wherein the moisture absorbent sheet has a cutout shaped to conform to the cutout of the holding sheet, or a hole shaped to conform to the hole of the holding sheet.

(5) The mobile device according to any one of Items (1) to (4), wherein the holding sheet has a planar shape formed into a ring shape for exposing the moisture absorbent sheet at a center portion thereof.

(6) The mobile device according to any one of Items (1) to (4), wherein the holding sheet has a plurality of moisture absorbing holes for partially exposing the moisture absorbent sheet.

(7) The mobile device according to any one of Items (1) to (6), wherein the holding sheet has moisture permeability.

(8) The mobile device according to any one of Items (1) to (7), further including a double-sided adhesive member configured to cause a lower surface of the moisture absorbent sheet to adhere to the inner surface of the back cover.

(9) The mobile device according to any one of Items (1) to (8), wherein the moisture absorbent sheet contains calcium oxide.

(10) The mobile device according to any one of Items (1) to (9), further including a piezoelectric element to be provided on the inner surface of the back cover, wherein the moisture absorbent sheet has a planar shape formed into a ring shape surrounding the piezoelectric element.

(11) The mobile device according to any one of Items (1) to (10), wherein the exterior case includes a body, and wherein any one of the back cover and the body includes a locking portion, and another one of the back cover and the body includes a locked portion to be locked to the locking portion.

(12) The mobile device according to Item (2), wherein the exterior case includes a body, and wherein any one of the back cover and the body has a female thread formed in an inner peripheral surface thereof, and another one of the back cover and the body has a male thread formed in an outer peripheral surface thereof to engage with the female thread.

(13) The mobile device according to any one of Items (1) to (12), further including an electrostatic induction-type converter including: a conductive substrate; an electret film which is to be formed on a surface of the conductive substrate, and is charged; and a counter electrode to be arranged so as to be opposed to the electret film, wherein the conductive substrate is to be provided so as to be relatively movable with respect to the counter electrode.

(14) The mobile device according to any one of Items (1) to (13), wherein the moisture absorbent sheet includes a plurality of laminated moisture absorbent sheets.

(15) The mobile device according to any one of Items (1) to (14), wherein the back cover has a recessed portion in the inner surface, and wherein the moisture absorbent sheet is provided on a bottom surface of the recessed portion.

(16) The mobile device according to Item (15), wherein the moisture absorbent sheet is provided so as to have a gap between the moisture absorbent sheet and a rising surface of the recessed portion.

### Advantageous Effects of Invention

According to the above-mentioned aspects of Items (1) to (16) of the present invention, the moderate humidity can be kept inside the device.

### BRIEF DESCRIPTION OF DRAWINGS

FIG. 1 is a plan view for illustrating a wristwatch according to a first embodiment of the present invention.

FIG. 2 is a sectional view taken along the line A-A of FIG. 1.

FIG. 3 is a sectional view for illustrating a configuration for holding a moisture absorbent sheet in the first embodiment.

FIG. 4 is a perspective view for illustrating a back cover in the first embodiment.

FIG. 5 is a plan view for illustrating an inner surface side of the back cover in the first embodiment.

FIG. 6 is a plan view for illustrating the moisture absorbent sheet in the first embodiment.

FIG. 7 is a plan view for illustrating a holding sheet in the first embodiment.

FIG. 8 is a plan view for illustrating a back cover in a second embodiment of the present invention.

FIG. 9 is a sectional view taken along the line IX-IX of FIG. 8.

FIG. 10 is a plan view for illustrating a moisture absorbent sheet and a holding sheet in a third embodiment of the present invention.

FIG. 11 is a plan view for illustrating a moisture absorbent sheet and a holding sheet in a fourth embodiment of the present invention.

FIG. 12 is a plan view for illustrating a moisture absorbent sheet and a holding sheet in a fifth embodiment of the present invention.

FIG. 13 is a plan view for illustrating a back cover in a sixth embodiment of the present invention.

FIG. 14 is a schematic sectional view for illustrating an example of a wristwatch including a built-in electrostatic induction-type converter in a seventh embodiment of the present invention.

FIG. 15 is a schematic perspective view of the electrostatic induction-type converter.

FIG. 16 is a schematic circuit diagram for illustrating an actuation principle at the time when the electrostatic induction-type converter is used as an electric generator.

FIG. 17 is a schematic circuit diagram for illustrating an actuation principle at the time when the electrostatic induction-type converter is used as an electric motor.

FIG. 18 is a sectional view for illustrating a configuration for holding a moisture absorbent sheet in an eighth embodiment of the present invention.

FIG. 19 is a plan view for illustrating the configuration for holding the moisture absorbent sheet in the eighth embodiment.

### DESCRIPTION OF EMBODIMENTS

Now, embodiments of the present invention are described in detail with reference to the drawings.

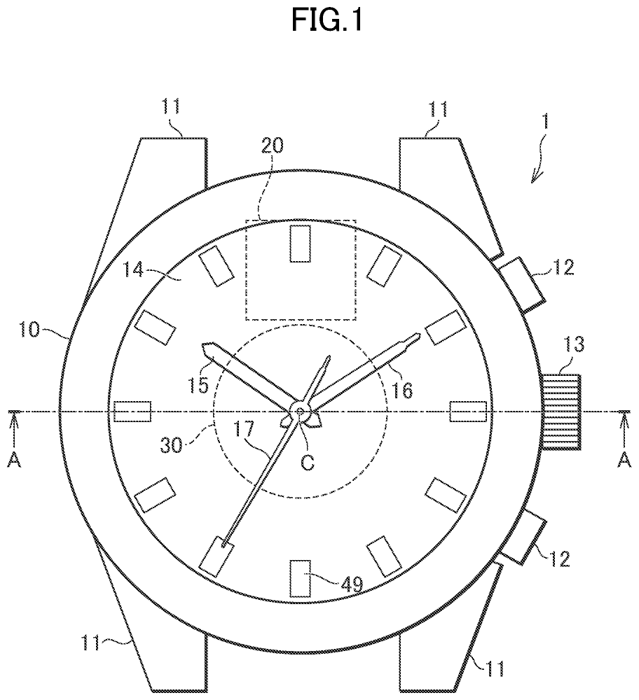

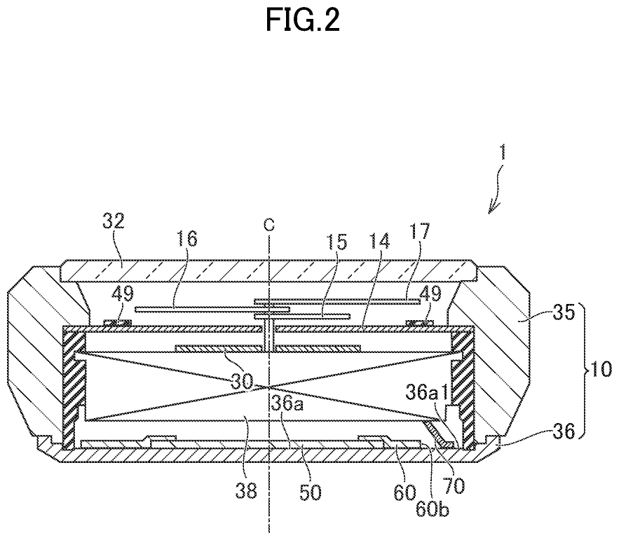

FIG. 1 is a plan view for illustrating a wristwatch according to a first embodiment of the present invention. FIG. 2 is a sectional view taken along the line A-A of FIG. 1. In FIG. 2, illustration of a crown 13 to be described later is omitted. Further, for the sake of easy understanding of an arrangement of hands, FIG. 2 shows a state in which a minute hand 16 is directed in the direction of 9 o'clock, and an hour hand 15 and a second hand 17 are directed in the direction of 3 o'clock.

A wristwatch 1 includes, as illustrated in FIG. 1, an exterior case 10, a dial 14, the hour hand 15, the minute hand 16, and the second hand 17. The exterior case 10 includes a body 35 and a back cover 36. The dial 14 is arranged inside the body 35. The hour hand 15, the minute hand 16, and the second hand 17 are hands for indicating time. The dial 14 has hour characters 49 provided at predetermined positions. Band fixing portions 11 configured to fix a band extend from side surfaces of the body 35 on the 12 o'clock side and the 6 o'clock side. Further, on a side surface of the body 35 on the 3 o'clock side, a button 12 and the crown 13 are arranged to allow a user to perform various operations.

The design of the wristwatch illustrated in FIG. 1 is merely an example. Other than the design shown here, for example, the body 35 may have a rectangular shape instead of having a round shape, and the presence/absence, the number, and the arrangement of the button 12 and the crown 13 can be freely set. Further, in FIG. 1, there are three hands of the hour hand 15, the minute hand 16, and the second hand 17, but the present invention is not limited thereto. The second hand 17 may be omitted, or there may be added a hand for giving various indications such as the day of the week, a time zone or the presence/absence of a summer time, and a radio-wave reception state or a remaining battery level, and date indications, for example.

In the present application, as the wristwatch 1, there is described a satellite radio-controlled wristwatch having a function of receiving, from a satellite configured to transmit a satellite signal including information related to the date and time, such as a global positioning system (GPS) satellite, the satellite signal, to thereby adjust an internal time held inside the watch based on the information related to the date and time included in the satellite signal. However, the present invention is not limited thereto, and the wristwatch may be a radio-controlled watch configured to receive a general standard radio wave to adjust the internal time, or a wristwatch not having such a time adjusting function.

As illustrated in FIG. 2, the wristwatch 1 includes a windshield 32 formed of a transparent material such as glass so as to cover the dial 14, and the windshield 32 is mounted to the body 35. Further, the back cover 36 is mounted to the body 35 on the opposite side of the windshield 32. In the present application, in the following, a side on which the windshield 32 is arranged (front side of the drawing sheet in FIG. 1) is referred to as “upper surface side,” and a side on which the back cover 36 is arranged (depth side of the drawing sheet in FIG. 1) is referred to as “lower surface side.” Further, a surface of each configuration on the upper surface side is referred to as “upper surface,” and a surface thereof on the lower surface side is referred to as “lower surface.”

On the lower surface side of the dial 14, a solar cell 30 is arranged. The solar cell 30 is configured to generate electric power through use of incident external light transmitted through the dial 14. The solar cell 30 includes a semiconductor layer and electrode layers. The semiconductor layer is made of, for example, silicon, and the electrode layers are arranged on an upper surface and a lower surface of the semiconductor layer, respectively. The solar cell 30 is configured to collect, by the electrode layers, charges generated in the semiconductor layer due to the incident external light, to thereby supply electric power from the electrode layers to a storage battery.

In the first embodiment, as indicated by the broken line of FIG. 1, the solar cell 30 has a planar shape formed into a circular shape, and is provided so that its center is positioned at a center C of the dial 14. Further, a patch antenna 20 is arranged on the back surface side of the dial 14 in a region in which the solar cell 30 is absent. The patch antenna 20 is configured to receive the satellite signal. As described above, the patch antenna 20 is arranged so as not to overlap with the solar cell 30 in plan view, thereby being capable of preventing a reception sensitivity of the patch antenna 20 from being affected by the electrodes included in the solar cell 30. In the first embodiment, the patch antenna 20 being a planar antenna configured to receive the satellite signal is given as an example of the antenna, but the present invention is not limited thereto. Other types of antenna may be used as long as the antenna receives a radio wave including time information or the like. Further, in the first embodiment, description is given of a radio-controlled watch including an antenna as an example, but the present invention is not limited to a radio-controlled watch. In this case, the effects on the reception sensitivity are not required to be considered, and hence the solar cell 30 may be provided so as to overlap with the entire dial 14. With such a configuration, a light receiving area of the solar cell 30 can be increased, and thus a power generation efficiency is improved.

As illustrated in FIG. 2, the wristwatch 1 further includes a movement 38 as a motive power mechanism. The movement 38 is provided on the lower side of the solar cell 30. The movement 38 is formed by integrally mounting the patch antenna 20, a wheel train and a motor configured to drive the hands, a clock circuit including a crystal unit configured to count the time, a controller configured to control the entire wristwatch 1, and the like onto a frame called a main plate. The movement 38 is configured to operate by obtaining electric power from the storage battery mounted to the movement 38. The storage battery is configured to supply electric power to the movement 38, and to simultaneously store electric power generated by the solar cell 30. For example, the storage battery is a button-type lithium secondary battery.

In the first embodiment, the solar cell 30 is integrally provided to the movement 38. Further, a hand shaft is provided to the movement 38 so as to protrude from a viewing surface of the dial 14. The second hand 17, the minute hand 16, and the hour hand 15 are mounted to a leading end of the hand shaft. Further, the windshield 32 is fixed to the body 35 so as to cover those components.

In the wristwatch 1, the solar cell 30 is not a necessary configuration, and the wristwatch 1 may include other electric generators such as an electric generator being an electrostatic induction-type converter to be described later in a seventh embodiment of the present invention.

Further, the wristwatch 1 includes an earth spring 70 corresponding to a conducting member extending from the movement 38 toward the back cover 36. The earth spring 70 is brought into contact with an inner surface 36a of the back cover 36 in an elastically deformed state, to thereby establish conduction between the movement 38 and the back cover 36. The earth spring 70 is provided so that, with a reaction force of an elastic force thereof, a state in which the earth spring 70 is brought into contact with the inner surface 36a of the back cover 36 is maintained. The inner surface 36a of the back cover 36 refers to a surface of the back cover 36 opposed to the movement 38 inside the wristwatch 1.

FIG. 2 shows a metal plate spring as the earth spring 70 corresponding to the conducting member, but the present invention is not limited thereto. It is only required that the contact state with respect to the inner surface 36a of the back cover 36, that is, a conducting state can be maintained. For example, the conducting member may be a metal spring to be brought into elastic contact with the inner surface 36a of the back cover 36.

Further, in the first embodiment, a moisture absorbent sheet 50 is provided on the inner surface 36a of the back cover 36. Details of a configuration for holding the moisture absorbent sheet 50 and the like are described below.

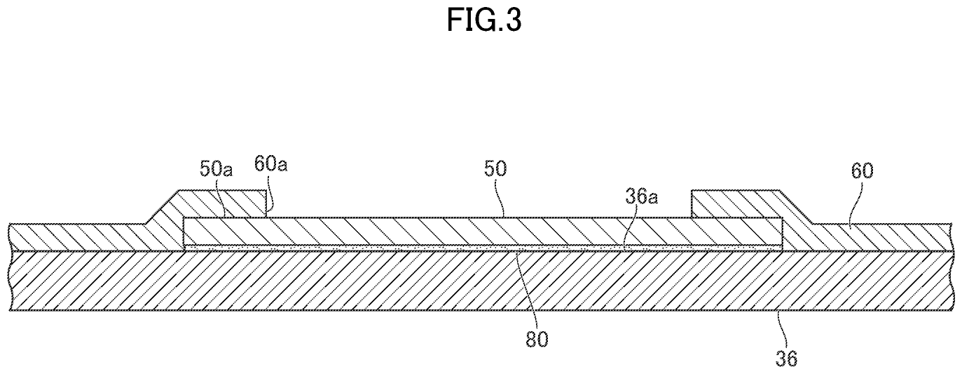

FIG. 3 is a sectional view for illustrating the configuration for holding the moisture absorbent sheet in the first embodiment. As illustrated in FIG. 3, on the inner surface 36a of the back cover 36, the moisture absorbent sheet 50, a holding sheet 60, and a double-sided adhesive sheet 80 corresponding to a double-sided adhesive member are provided.

The moisture absorbent sheet 50 plays a role to keep a moderate humidity inside the wristwatch 1 by absorbing moisture. The moisture absorbent sheet 50 may contain a substance that changes in composition when a chemical reaction occurs with water such as moisture. The substance is, for example, calcium oxide. Such a moisture absorbent sheet 50 absorbs moisture to expand. The moisture absorbent sheet 50 containing calcium oxide has a large allowable moisture absorbing amount and a small size, and is thus suitable for being used in a mobile device such as a wristwatch. However, the present invention is not limited thereto, and there may be used a moisture absorbent sheet containing a material including zeolite or the like to repeatedly absorb and desorb moisture.

The double-sided adhesive sheet 80 is provided so that an upper surface thereof is caused to adhere to a lower surface of the moisture absorbent sheet 50, and a lower surface thereof is caused to adhere to the inner surface 36a of the back cover 36. Through use of the double-sided adhesive sheet 80, under a state in which the position of the moisture absorbent sheet 50 is temporarily determined on the inner surface 36a of the back cover 36, the moisture absorbent sheet 50 can be held by the holding sheet 60. That is, the moisture absorbent sheet 50 can be arranged on the inner surface 36a of the back cover 36 with high positional accuracy. However, the double-sided adhesive sheet 80 is not a necessary configuration, and there may be employed a configuration in which the moisture absorbent sheet 50 is held only by the holding sheet 60. Further, in the first embodiment, a sheet-shaped double-sided adhesive sheet 80 is given as an example of the double-sided adhesive member, but the present invention is not limited thereto. There may be employed a configuration in which an adhesive is used to cause the moisture absorbent sheet 50 to adhere to the inner surface 36a of the back cover 36.

Although not shown, the double-sided adhesive sheet 80 may have a plurality of holes or slits, for example. With such a configuration being adopted, when the moisture absorbent sheet 50 absorbs moisture to expand, the expansion is allowed into the holes or the slits of the double-sided adhesive sheet 80. Therefore, even when the moisture absorbent sheet 50 expands, the moisture absorbent sheet 50 is less liable to peel off by coming off from the double-sided adhesive sheet 80.

The holding sheet 60 is an adhesive sheet having an adhesive layer on its lower surface. The holding sheet 60 is provided so as to adhere to the inner surface 36a of the back cover 36 around the moisture absorbent sheet 50, and to cover an edge 50a of the moisture absorbent sheet 50 and adhere to the edge 50a. In this manner, the moisture absorbent sheet 50 is held on the inner surface 36a of the back cover 36. In the first embodiment, description is given of an example in which the holding sheet 60 adheres to the inner surface 36a of the back cover 36 and the edge 50a of the moisture absorbent sheet 50, but the present invention is not limited thereto. It is only required to employ a configuration in which the holding sheet 60 is configured to at least adhere to the inner surface 36a of the back cover 36 and cover the edge 50a of the moisture absorbent sheet 50, to thereby hold the moisture absorbent sheet 50 on the inner surface 36a of the back cover 36.

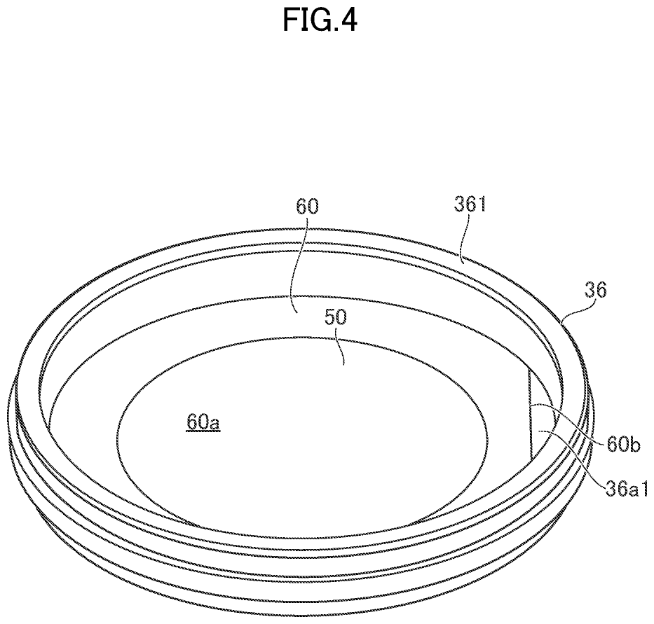

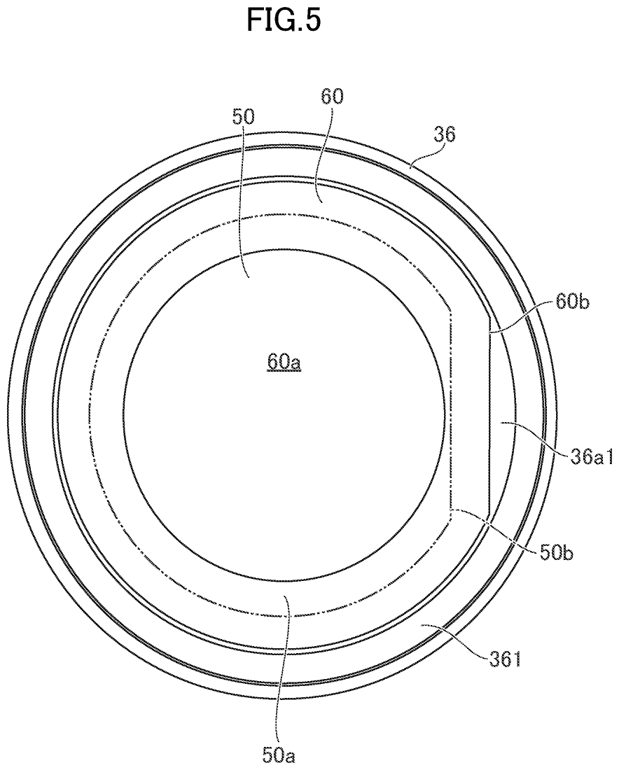

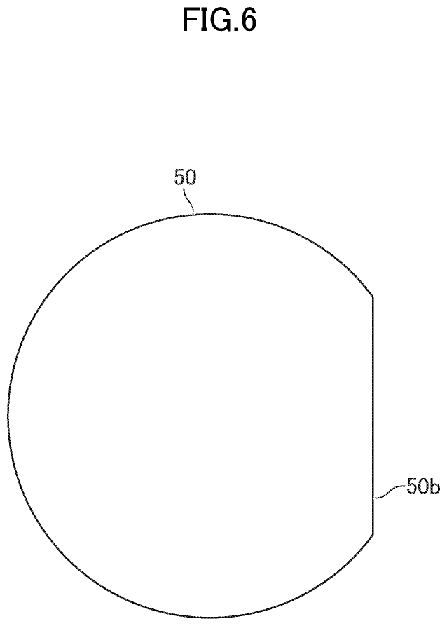

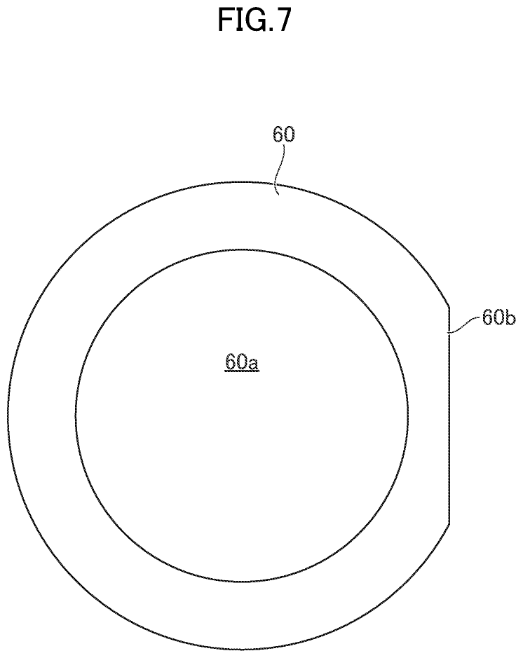

FIG. 4 is a perspective view for illustrating the back cover in the first embodiment. FIG. 5 is a plan view for illustrating an inner surface side of the back cover in the first embodiment. FIG. 6 is a plan view for illustrating the moisture absorbent sheet in the first embodiment. FIG. 7 is a plan view for illustrating the holding sheet in the first embodiment.

In the first embodiment, the back cover 36 has an outer shape formed into a substantially disc shape, and the inner surface 36a thereof has a planar shape formed into a substantially circular shape. Further, the back cover 36 has an annular wall 361 rising at the edge so as to surround the inner surface 36a. The body 35 is fitted to the inner side of this wall 361 so that the back cover 36 is fixed with respect to the body 35. Although not shown, in the first embodiment, the following so-called snap back-type back cover 36 may be used. Specifically, one of the wall 361 and the body 35 includes a groove corresponding to a locked portion, and another one thereof includes a locking claw corresponding to a locking portion. The locking claw is fitted to the groove so that the back cover 36 is positioned and fixed with respect to the body 35.

As illustrated in FIG. 5 and FIG. 6, the moisture absorbent sheet 50 has a planar shape formed into a substantially circular shape, and has a cutout formed in a part thereof in a circumferential direction so as to form a linear end surface 50b. The long dashed double-short dashed line of FIG. 5 indicates the outer shape of the moisture absorbent sheet 50.

As illustrated in FIG. 5 and FIG. 7, the holding sheet 60 has a planar shape formed into a ring shape having a circular opening 60a at its center, and has a cutout formed in a part thereof in the circumferential direction so as to form a linear end surface 60b. With this cutout, a part of the inner surface 36a of the back cover 36 is exposed. In the following, an exposed region of the inner surface 36a of the back cover 36 is referred to as “exposed region 36a1.” In the first embodiment, description is given of an example in which, as illustrated in FIG. 2 and FIG. 5, for example, a cutout is formed in the holding sheet 60 at a 3 o'clock position to form the exposed region 36a1. However, the present invention is not limited thereto, and as described later, the exposed region 36a1 is only required to be formed at a position corresponding to the position of the earth spring 70.

The end surface 60b may be formed at a position of, for example, when the holding sheet 60 has a radius of 18 mm, about 16 mm from the center of the holding sheet 60.

The holding sheet 60 is provided so as to cover the edge 50a of the moisture absorbent sheet 50. A region of the moisture absorbent sheet 50 overlapping with the opening 60a of the holding sheet 60 in plan view is exposed. The moisture absorbent sheet 50 absorbs moisture in the region exposed from the holding sheet 60, to thereby keep a moderate humidity inside the wristwatch 1.

In this case, when static electricity is generated inside the movement 38, for example, the operation of the movement 38 or the reception sensitivity of the patch antenna 20 may be affected. Therefore, in order to eliminate the static electricity generated inside the movement 38, the movement 38 is required to be grounded. As a measure therefor, it is conceivable to establish conduction between the movement 38 and the metal back cover 36. Among the metal components forming the wristwatch, the back cover 36 having a relatively large size can be used as the ground to reliably ground the movement 38.

However, when the moisture absorbent sheet 50 or the holding sheet 60 is arranged on the entire inner surface 36a of the back cover 36, the conduction cannot be established between the movement 38 and the back cover 36. In particular, in the first embodiment, there is adopted a configuration in which the holding sheet 60 is caused to adhere around the moisture absorbent sheet 50 on the inner surface 36a of the back cover 36, and hence a large region of the inner surface 36a of the back cover 36 is covered with the moisture absorbent sheet 50 or the holding sheet 60.

In view of the above, in the first embodiment, as described above, a cutout is formed in the holding sheet 60 so that a part of the inner surface 36a of the back cover 36 is exposed. Further, the earth spring 70 extending from the movement 38 to the back cover 36 is arranged to be in contact with the exposed region 36a1 of the inner surface 36a of the back cover 36 (see, for example, FIG. 2). In this manner, even when the moisture absorbent sheet 50 is provided on the back cover 36, the conduction can be established between the movement 38 and the back cover 36.

In the first embodiment, description is given of an example in which the cutout is formed in the holding sheet 60, but the present invention is not limited thereto. The holding sheet 60 is only required to have a shape that allows a part of the inner surface 36a of the back cover 36 to be exposed. For example, there may be employed a configuration in which the holding sheet 60 has a hole in place of the cutout so that a part of the inner surface 36a of the back cover 36 is exposed from the hole. Also in this configuration, the earth spring 70 may be provided so as to be in contact with a region of the inner surface 36a of the back cover 36, which is exposed from the hole of the holding sheet 60.

In the first embodiment described above, the moisture absorbent sheet 50 has its edge 50a held and covered with the holding sheet 60. Thus, even when the moisture absorbent sheet 50 absorbs moisture to expand, the edge 50a is less liable to come off from the inner surface 36a of the back cover 36. Therefore, the moisture absorbent sheet 50 is less liable to peel off from the inner surface 36a of the back cover 36. As described above, the moisture absorbent sheet 50 is stably held, and thus an appropriate humidity can be kept inside the wristwatch 1. Further, the coming-off and warping of the edge 50a of the moisture absorbent sheet 50 are suppressed to suppress interference with other surrounding members. That is, the contact of the peeled-off moisture absorbent sheet 50 with other components is suppressed to suppress hindering of a mechanical motion.

Further, in the configuration of the first embodiment in which the cutout is formed in the holding sheet 60, the moisture absorbent sheet 50 can be provided on the back cover 36, and also the movement 38 can be grounded. Therefore, the static electricity generated inside the movement 38 can be eliminated, and the movement 38 can be stably operated.

In the example illustrated in FIG. 5, for example, a cutout is formed also in the moisture absorbent sheet 50 so as to form the linear end surface 50b so that the entire circumference of the edge 50a of the moisture absorbent sheet 50 is covered with the holding sheet 60. However, the present invention is not limited to such a shape. Regardless of the shape of the moisture absorbent sheet 50, as long as at least the entire circumference of the edge 50a of the moisture absorbent sheet 50 is covered with the holding sheet 60, the peeling-off of the edge 50a of the moisture absorbent sheet 50 is suppressed. However, it is not necessary to cover the entire circumference of the edge 50a of the moisture absorbent sheet 50 with the holding sheet 60. That is, at least a part of the edge 50a of the moisture absorbent sheet 50 may be covered with the holding sheet 60. For example, the moisture absorbent sheet 50 may be covered with the holding sheet 60 at a plurality of portions in the circumferential direction. With the holding sheet 60 being adopted as described above, as compared to a configuration in which the moisture absorbent sheet 50 is held only by the double-sided adhesive sheet 80, the moisture absorbent sheet 50 is less liable to peel off.

In the first embodiment, description is given of an example in which one moisture absorbent sheet 50 is provided, but the present invention is not limited thereto. A plurality of moisture absorbent sheets 50 may be provided. In this case, the moisture absorbent sheets 50 may be bonded to each other by a double-sided adhesive sheet 80.

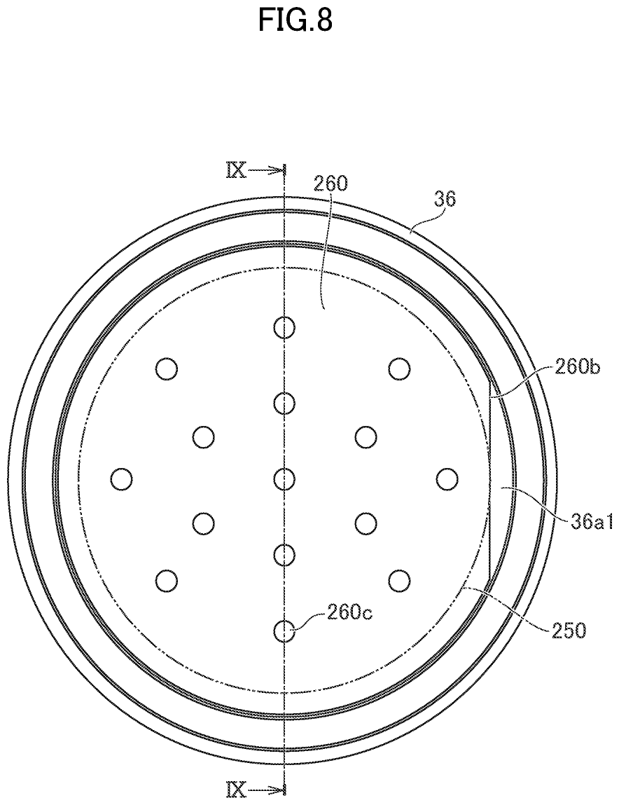

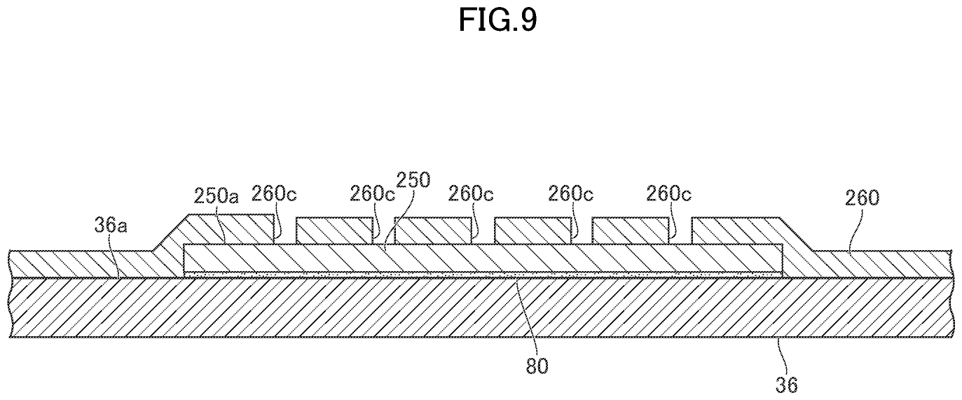

Next, with reference to FIG. 8 and FIG. 9, a second embodiment of the present invention is described. FIG. 8 is a plan view for illustrating a back cover in the second embodiment. FIG. 9 is a sectional view taken along the line IX-IX of FIG. 8. Like configurations as those of the first embodiment are denoted by like reference symbols, and detailed description thereof is omitted here. The long dashed double-short dashed line of FIG. 8 indicates a moisture absorbent sheet 250.

A holding sheet 260 in the second embodiment has a planar shape formed into a substantially circular shape, and similarly to the holding sheet 60 in the first embodiment, a cutout is formed in a part thereof in the circumferential direction so as to form a linear end surface 260b. Further, the holding sheet 260 covers substantially the entire moisture absorbent sheet 250, and has a plurality of moisture absorbing holes 260c for partially exposing the moisture absorbent sheet 250. The moisture absorbent sheet 250 absorbs moisture inside the wristwatch 1 via those moisture absorbing holes 260c. In the second embodiment, the holding sheet 260 covers the moisture absorbent sheet 250 in a large region, and thus the moisture absorbent sheet 250 is further less liable to peel off. The number and the shape of the moisture absorbing holes 260c are merely examples, and the present invention is not limited to those illustrated in FIG. 8 and FIG. 9. Further, the planar shape of the holding sheet 260 may be a ring shape similarly to the holding sheet 60 described in the first embodiment. When the holding sheet 260 is formed into a ring shape and further configured to have the moisture absorbing holes 260c, an area of the exposed region of the moisture absorbent sheet 250 is increased, and the moisture absorbent sheet 250 can more easily absorb the moisture inside the wristwatch 1.

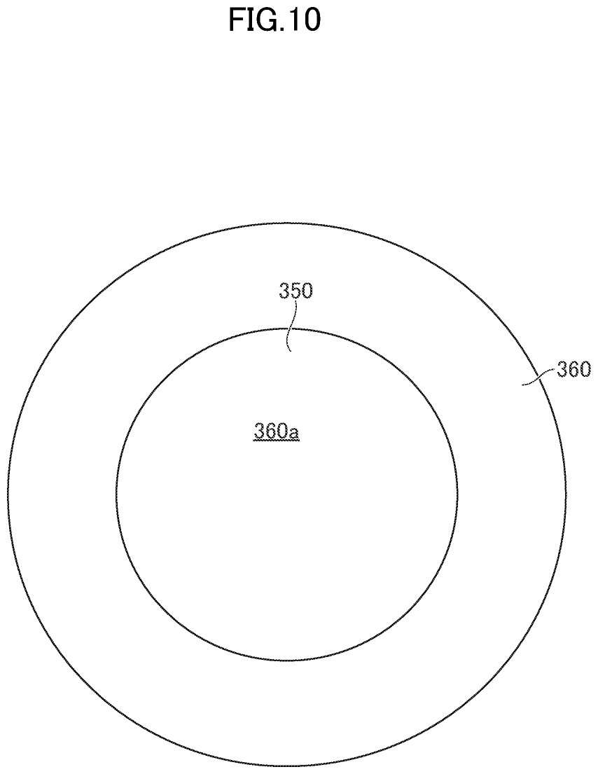

Next, with reference to FIG. 10, a third embodiment of the present invention is described. FIG. 10 is a plan view for illustrating a moisture absorbent sheet and a holding sheet in the third embodiment. Like configurations as those of the first embodiment are denoted by like reference symbols, and detailed description thereof is omitted here. In FIG. 10, the illustration of the back cover 36 is omitted.

In the third embodiment, a moisture absorbent sheet 350 has a substantially circular shape, and a holding sheet 360 has a ring shape having an opening 360a at its center portion. Further, a diameter of the moisture absorbent sheet 350 is larger than a diameter of the opening 360a of the holding sheet 360, and an edge of the moisture absorbent sheet 350 is covered with the holding sheet 360. Further, the holding sheet 360 is formed to have substantially the same size as that of the inner surface 36a of the back cover 36. Therefore, in the third embodiment, there is employed a configuration in which the earth spring 70 (see FIG. 2) cannot be brought into direct contact with the back cover 36.

Thus, in the third embodiment, a sheet having conductivity is adopted as the holding sheet 360. The earth spring 70 is brought into contact with the holding sheet 360 to establish conduction with the back cover 36 via the holding sheet 360. That is, the movement 38 is grounded to the back cover 36 via the earth spring 70 and the holding sheet 360.

In the third embodiment, as compared to the first embodiment in which the earth spring 70 is required to be arranged to be in contact with the exposed region 36a1 of the back cover 36, even when the earth spring 70 is arranged at any position in the circumferential direction of the back cover 36, the movement 38 is allowed to be grounded. Therefore, the degree of freedom in layout inside the movement 38 to which the earth spring 70 is provided is improved.

The configuration of the third embodiment is effective particularly when a screw back-type back cover is used. Here, the screw back-type back cover is a back cover that can be screwed into the body to be fixed. Specifically, the screw back-type back cover refers to a configuration in which a female thread is formed in an inner peripheral surface of any one of the back cover and the body, a male thread is formed in an outer peripheral surface of another one of the back cover and the body to engage with the female thread, and the back cover can be screwed into the body to be fixed. It may be difficult to adopt the screw back-type back cover with respect to the first embodiment or the like, in which the earth spring 70 can establish conduction only in a predetermined region of the inner surface 36a of the back cover 36. Meanwhile, with the configuration of the third embodiment being adopted, the movement 38 can be reliably grounded not only in the case of the snap back type but also in the case in which the screw back-type back cover is used.

Further, in the holding sheet 360 in the third embodiment, a cutout or holes for conduction are not required to be formed unlike the holding sheet 60 in the first embodiment. Further, in the first embodiment, the holding sheet 60 is required to be positioned in accordance with the position of the earth spring 70, but when the holding sheet 360 is used, such positioning is unnecessary. Therefore, the number of steps in the manufacturing process can be reduced, which leads to reduction in cost.

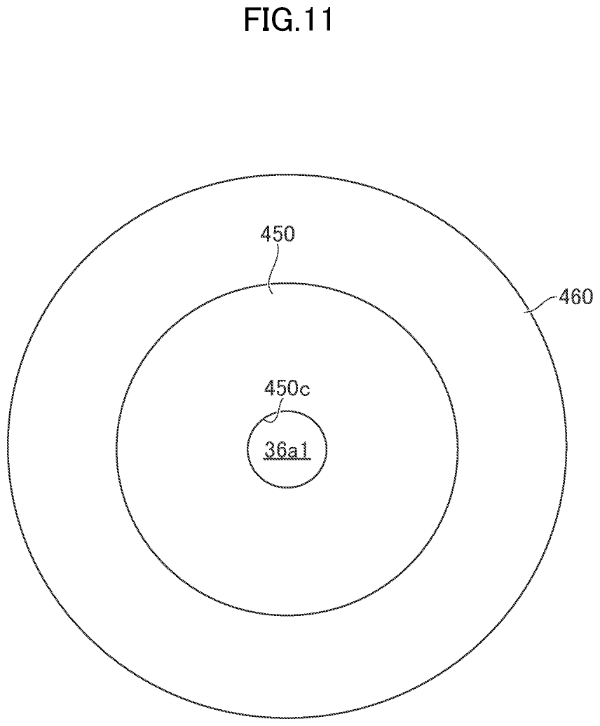

With reference to FIG. 11, a fourth embodiment of the present invention is described. FIG. 11 is a plan view for illustrating a moisture absorbent sheet and a holding sheet in the fourth embodiment. Like configurations as those of the first embodiment are denoted by like reference symbols, and detailed description thereof is omitted here. In FIG. 11, the illustration of the back cover 36 is omitted.

A holding sheet 460 has a planar shape formed into a ring shape. Further, a moisture absorbent sheet 450 also has a planar shape formed into a ring shape having an opening 450c formed at its center portion. With the opening 450c, a part of the inner surface 36a of the back cover 36 is exposed. A region of the inner surface 36a of the back cover 36, which is exposed from the opening 450c, is illustrated in FIG. 11 as the exposed region 36a1.

In the fourth embodiment, the earth spring 70 may be provided to extend from the vicinity of the center portion of the movement 38 so as to be in contact with the exposed region 36a1 illustrated in FIG. 11. The opening 450c is formed at the center portion of the back cover 36, and hence regardless of a relative position between the back cover 36 and the body 35, a relative position between the back cover 36 and the earth spring 70 is maintained. Therefore, in the configuration of the fourth embodiment, the movement 38 can be reliably grounded even when the above-mentioned screw back-type back cover is adopted.

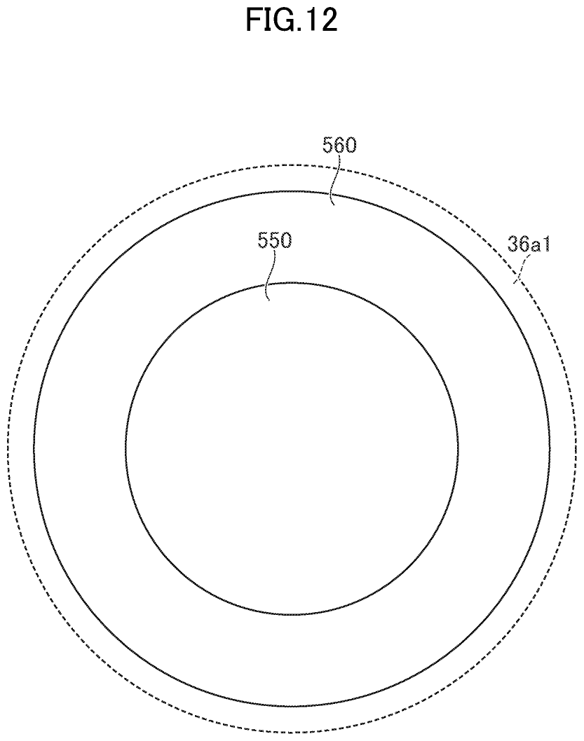

With reference to FIG. 12, a fifth embodiment of the present invention is described. FIG. 12 is a plan view for illustrating a moisture absorbent sheet and a holding sheet in the fifth embodiment. Like configurations as those of the first embodiment are denoted by like reference symbols, and detailed description thereof is omitted here. In FIG. 12, the broken line indicates the outer shape of the inner surface 36a of the back cover 36.

A holding sheet 560 has a planar shape formed into a ring shape. Further, a moisture absorbent sheet 550 has a planar shape formed into a circular shape. In the fifth embodiment, the size of the outer shape of the holding sheet 560 is set to be smaller than the size of the outer shape of the inner surface 36a of the back cover 36. Therefore, the inner surface 36a is annularly exposed around the holding sheet 560. An exposed region of the inner surface 36a of the back cover 36 is illustrated in FIG. 12 as the exposed region 36a1.

In the fifth embodiment, the earth spring 70 may be provided to extend from the vicinity of an outer periphery of the movement 38 so as to be in contact with the exposed region 36a1 illustrated in FIG. 12. In the configuration of the fifth embodiment, the earth spring 70 is in contact with any region in the vicinity of an outer periphery of the back cover 36. Therefore, the movement 38 can be reliably grounded even when the above-mentioned screw back-type back cover is adopted.

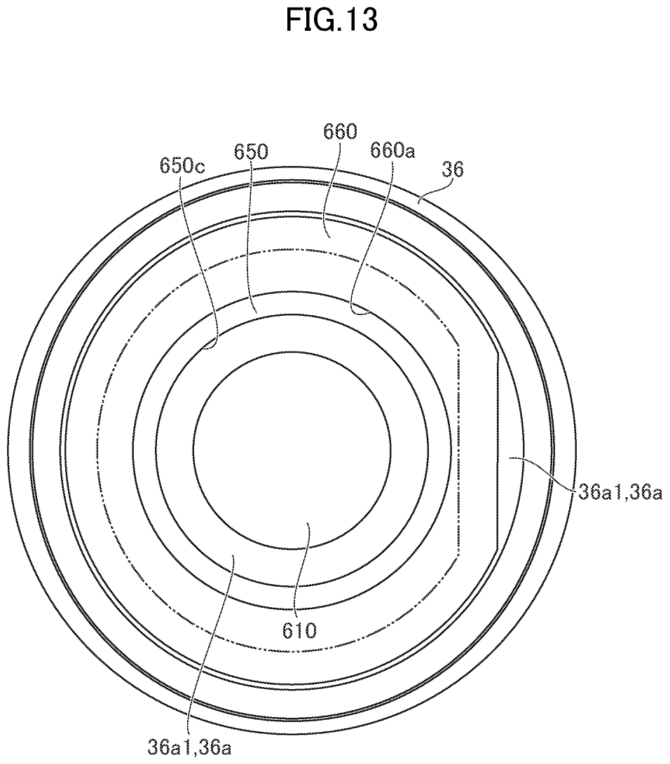

With reference to FIG. 13, a sixth embodiment of the present invention is described. FIG. 13 is a plan view for illustrating a back cover in the sixth embodiment. Like configurations as those of the first embodiment are denoted by like reference symbols, and detailed description thereof is omitted here. The wristwatch 1 according to the sixth embodiment relates to a wristwatch with an alarm function. Specifically, the wristwatch 1 accommodates therein a piezoelectric element 610, and is configured to apply a voltage to the piezoelectric element 610 to cause air vibration, to thereby output an alarm.

In the sixth embodiment, the piezoelectric element 610 is provided in the vicinity of the center portion of the inner surface 36a of the back cover 36. The piezoelectric element 610 may be held on the inner surface 36a of the back cover 36 by a double-sided adhesive sheet or an adhesive, for example.

Further, in the sixth embodiment, a moisture absorbent sheet 650 and a holding sheet 660 each have a planar shape formed into a ring shape surrounding the piezoelectric element 610. That is, the moisture absorbent sheet 650 has an opening 650c at its center portion, and the holding sheet 660 has an opening 660a at its center portion.

As illustrated in FIG. 13, the inner surface 36a of the back cover 36 is annularly exposed between the piezoelectric element 610 and an inner edge (edge formed by the opening 650c) of the moisture absorbent sheet 650. Further, similarly to the first embodiment, for example, a cutout is formed in a part of each of the moisture absorbent sheet 650 and the holding sheet 660 in the circumferential direction so as to form a linear end surface. In this manner, a part of the inner surface 36a of the back cover 36 is exposed. An exposed region of the inner surface 36a of the back cover 36 is illustrated in FIG. 13 as the exposed region 36a1.

Also in the sixth embodiment, the earth spring 70 may be provided so as to be in contact with any position of the exposed region 36a1.

FIG. 13 shows an example in which the holding sheet 660 covers a part of the edge of the moisture absorbent sheet 650, but there may be employed a configuration in which the holding sheet 660 covers substantially the entire surface of the moisture absorbent sheet 650. In this case, for example, a plurality of moisture absorbing holes may be formed in the holding sheet 660 so as to partially expose the moisture absorbent sheet 650.

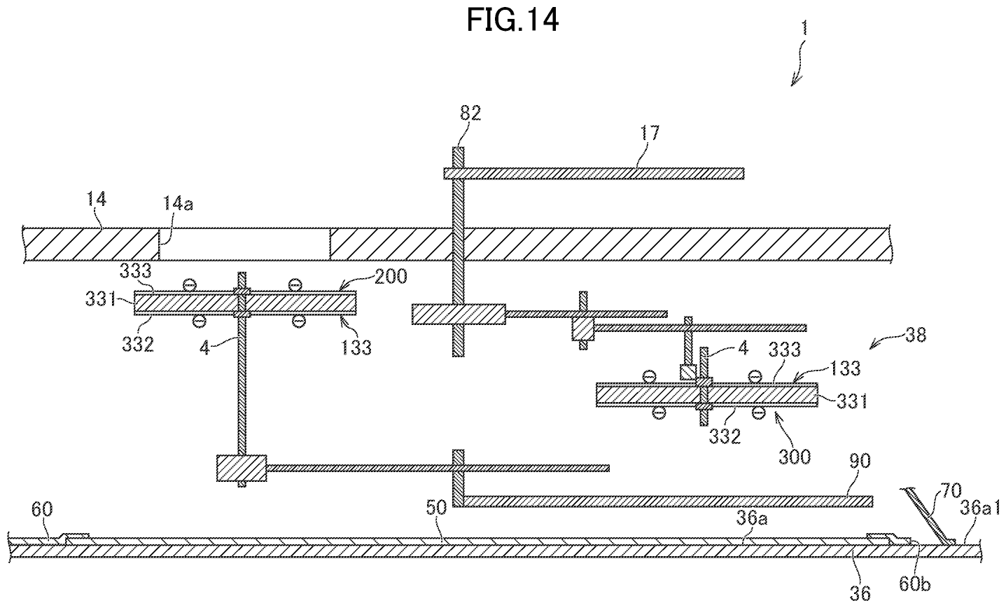

With reference to FIG. 14 to FIG. 17, a seventh embodiment of the present invention is described. In the seventh embodiment, the wristwatch 1 described in the first embodiment includes a built-in electrostatic induction-type converter.

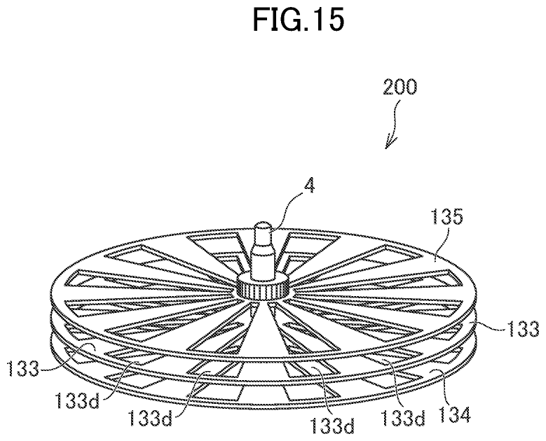

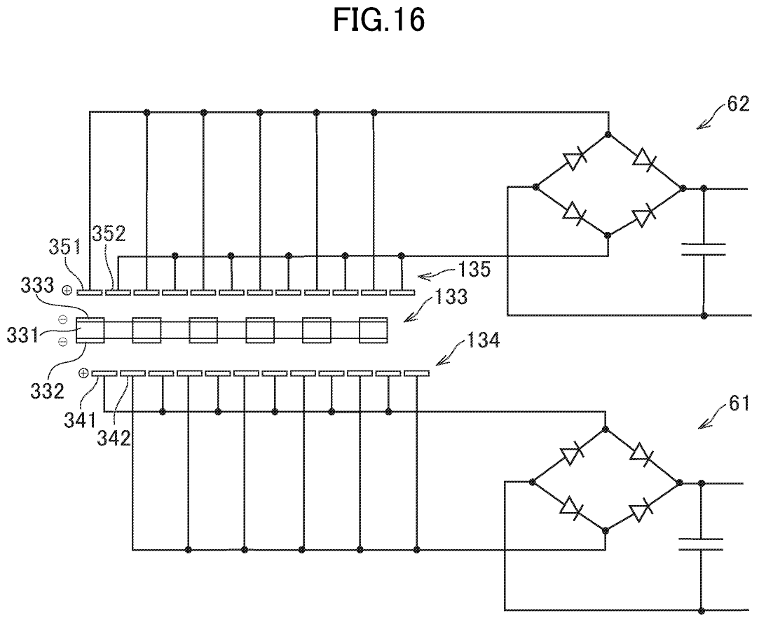

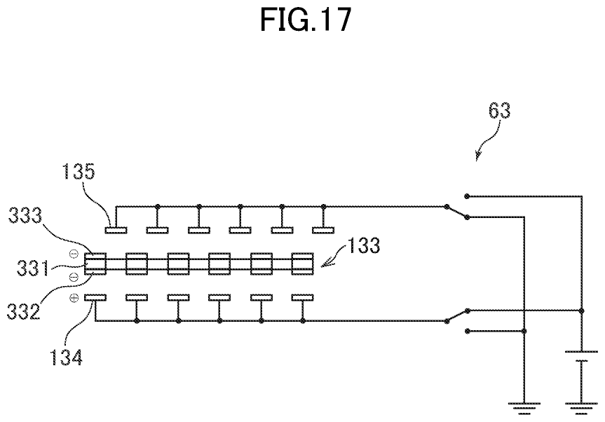

FIG. 14 is a schematic sectional view for illustrating an example of a wristwatch including a built-in electrostatic induction-type converter in the seventh embodiment. FIG. 15 is a schematic perspective view of the electrostatic induction-type converter. FIG. 16 is a schematic circuit diagram for illustrating an actuation principle at the time when the electrostatic induction-type converter is used as an electric generator. FIG. 17 is a schematic circuit diagram for illustrating an actuation principle at the time when the electrostatic induction-type converter is used as an electric motor. In FIG. 14, the internal configuration of the wristwatch 1 is schematically illustrated with components being omitted as appropriate. Further, illustration of a first counter electrode 134 and a second counter electrode 135 is omitted.

In this case, the electrostatic induction-type converter means a device configured to use electrostatic induction to perform mutual conversion between kinetic energy and electrical energy, and refers to an electric generator or an electric motor. Its principle is described later, but when an external force is caused to act on the electrostatic induction-type converter to apply kinetic energy thereto, the energy can be converted into electrical energy to be extracted. This corresponds to an electric generator. Further, when electrical energy is applied to the electrostatic induction-type converter, the energy can be extracted as kinetic energy. This corresponds to an electric motor.

As illustrated in FIG. 14, in the seventh embodiment, the wristwatch 1 includes an electrostatic induction-type converter 200 serving as an electric generator, and an electrostatic induction-type converter 300 serving as an electric motor. Those electrostatic induction-type converters 200 and 300 may be accommodated in, for example, the movement 38.

In the example illustrated in FIG. 14, the electrostatic induction-type converter 200 serving as the electric generator is configured to convert a rotary motion of a rotary weight 90 into electrical energy to extract the electrical energy, and supply the electrical energy to the storage battery. Further, in the example illustrated in FIG. 14, the electrostatic induction-type converter 300 serving as the electric motor is configured to drive the second hand 17 to rotate via a wheel train and a hand shaft 82.

Further, FIG. 14 shows a configuration in which a viewing hole 14a is formed in the dial 14 so that an electret substrate 133 included in the electrostatic induction-type converter 200 serving as the electric generator can be viewed from the outside. With such a configuration, a user can enjoy the operation and the design of the electret substrate 133. When the configuration in which the user views the electret substrate 133 is adopted, a counter electrode provided on the viewing hole 14a side may be a transparent electrode. Alternatively, a transparent substrate may be arranged on the viewing hole 14a side, and a transparent conductive film being the counter electrode may be formed on the transparent substrate.

In the seventh embodiment, as illustrated in FIG. 14, the exposed region 36a1 of the inner surface 36a of the back cover 36 is formed on an outer side of a rotation locus of the rotary weight 90. That is, the cutout is formed so that the linear end surface 60b formed in the holding sheet 60 is provided on the outer side of the rotation locus of the rotary weight 90. Further, the earth spring 70 is provided on the outer side of the rotation locus of the rotary weight 90 so as to be in contact with the exposed region 36a1. Therefore, the rotary weight 90 does not interfere with the earth spring 70.

Various configurations such as the wheel train illustrated in FIG. 14 and the arrangements of the electrostatic induction-type converters 200 and 300 are merely examples, and the present invention is not limited thereto.

In this case, as described later, the electrostatic induction-type converter includes a charged electret film, and the charged state of the electret film may be affected when the humidity inside the wristwatch 1 is increased. In view of the above, the moisture absorbent sheet 50 described in the first embodiment is provided on the back cover 36, thereby being capable of keeping a moderate humidity inside the wristwatch 1 and stabilizing the charged state of the electret film. In this manner, the electrostatic induction-type converter can be operated more normally as the electric generator or the electric motor.

The electrostatic induction-type converter 200 illustrated in FIG. 15 is an example of an electric generator configured to change a mechanical rotary motion to electrical energy. The electrostatic induction-type converter 300 serving as the electric motor configured to extract electrical energy as a mechanical rotary motion has a structure similar to that illustrated in FIG. 15. Now, the basic structure of the electrostatic induction-type converter is described.

The electrostatic induction-type converter 200 includes, as main components, the first counter electrode 134 having a disc shape, the second counter electrode 135 having a disc shape, the electret substrate 133 having a disc shape, and a rotary shaft 4. The electret substrate 133 is arranged so as to be sandwiched between the first counter electrode 134 and the second counter electrode 135 with predetermined intervals being secured therebetween. In this case, the disc shape refers to a shape of a member formed like a substantially flat disc as a whole, and there is no problem even when the member has, in its surface, through holes 133d formed as appropriate as illustrated in FIG. 15, or has an outer peripheral portion being processed to have a cutout, a convex portion, or the like.

The electret substrate 133 includes a conductive substrate 331, a first electret film 332, and a second electret film 333. The first electret film 332 is formed on a lower surface of the conductive substrate 331. The second electret film 333 is formed on an upper surface of the conductive substrate 331. In the example illustrated in FIG. 15, the conductive substrate 331 has a plurality of through holes 133d formed therein, which are arranged side by side in the circumferential direction. Therefore, the electret substrate 133 has a configuration in which a region with an electret film and a region without an electret film are alternately arranged in the circumferential direction.

In this case, an easily chargeable material is used as the material of the electret film. For example, as a material to be negatively charged, there are silicon oxide and a fluororesin, for example. As a specific example of such a material, there can be given CYTOP (trademark) being a fluororesin produced by Asahi Glass Co., Ltd. Further, as other materials of the electret film, there can be used polymer materials such as polypropylene, polyethylene terephthalate, polyvinyl chloride, polystyrene, polytetrafluoroethylene, polyvinylidene difluoride, and polyvinyl fluoride, and inorganic materials such as silicon oxide described above, silicon nitride, and silicon oxynitride.

Further, in the example illustrated in FIG. 15, the first counter electrode 134 and the second counter electrode 135 each have a plurality of through holes arranged side by side in the circumferential direction. That is, the first counter electrode 134 and the second counter electrode 135 each have a configuration in which a region with an electrode and a region without an electrode are alternately arranged in the circumferential direction. The counter electrode illustrated in FIG. 15 is merely an example, and, for example, there may be employed a configuration in which a plurality of conductive films are arranged side by side in the circumferential direction on a surface of a disc-shaped substrate.

The electret substrate 133 is provided so as to be rotatable about the rotary shaft 4. Meanwhile, the first counter electrode 134 and the second counter electrode 135 are provided in a fixed manner. Therefore, along with the rotation of the electret substrate 133, a facing state in which the first electret film 332 and the second electret film 333 face the first counter electrode 134 and the second counter electrode 135, and a non-facing state are switched. The electret substrate 133 and the first and second counter electrodes 134 and 135 are only required to be provided so as to be relatively movable. For example, there may be employed a configuration in which the electret substrate 133 is provided in a fixed manner, and the first counter electrode 134 and the second counter electrode 135 are provided so as to be rotatable.

FIG. 16 is a schematic circuit diagram for illustrating an actuation principle at the time when the electrostatic induction-type converter is used as an electric generator.

The first electret film 332 and the second electret film 333 are each formed to have a predetermined charged state. In this example, the first electret film 332 and the second electret film 333 are both charged to have negative charges.

Under a state in which the first counter electrode 134 and the second counter electrode 135 face the first electret film 332 and the second electret film 333, surface charges of the first electret film 332 and the second electret film 333 induce charges having an opposite polarity in the first counter electrode 134 and the second counter electrode 135 so that the charges are accumulated in the first counter electrode 134 and the second counter electrode 135 (in this example, positive charges are accumulated in the first counter electrode 134 and the second counter electrode 135).

After that, when the electret substrate 133 is rotated to achieve a state in which the first electret film 332 and the second electret film 333 do not face the first counter electrode 134 and the second counter electrode 135, the charges induced and accumulated in the first counter electrode 134 and the second counter electrode 135 are swept, to thereby be rectified by rectifier circuits 61 and 62 and extracted as electrical energy.

FIG. 16 shows an example in which a plurality of first counter electrodes 341 of the first counter electrode 134 are arranged side by side with intervals secured in the circumferential direction, and a plurality of first counter electrodes 342 are arranged therebetween. Further, the first counter electrodes 341 and the first counter electrodes 342 are connected to the rectifier circuit 61 so that the electrical energy can be extracted from each of the electrodes.

Further, a plurality of second counter electrodes 351 of the second counter electrode 135 are arranged side by side in a phase different from that of the first counter electrode 134, with intervals secured in the circumferential direction, and a plurality of second counter electrodes 352 are arranged therebetween. Further, the second counter electrodes 351 and the second counter electrodes 352 are connected to the rectifier circuit 62 so that the electrical energy can be extracted from each of the electrodes.

FIG. 17 is a schematic circuit diagram for illustrating an actuation principle at the time when the electrostatic induction-type converter is used as an electric motor. Also in this case, the electret substrate 133 and the first and second counter electrodes 134 and 135 are arranged so as to be parallel and opposed to each other with predetermined slight intervals secured therebetween. Further, along with the rotation of the electret substrate 133, a facing state in which the first electret film 332 and the second electret film 333 face the first counter electrode 134 and the second counter electrode 135, and a non-facing state are switched.

Further, the first counter electrode 134 and the second counter electrode 135 are arranged so as to have different phases in the moving direction of the electret substrate 133, and are each allowed to be applied with opposite charges of the charged state of the first electret film 332 or the second electret film 333 by a switch circuit 63 at a predetermined timing.

At this time, when any one of the first counter electrode 134 and the second counter electrode 135 is applied with opposite charges of the charged state of the first electret film 332 or the second electret film 333, due to an electrostatic force, the electret substrate 133 is moved so that the first electret film 332 or the second electret film 333 faces the counter electrode applied with the opposite charges. When the switch circuit 63 is appropriately switched to timely switch whether or not to apply opposite charges to the first counter electrode 134 or the second counter electrode 135 alternately, the electret substrate 133 can be continuously moved, and the electret substrate 133 can be driven to rotate. The rotational drive of the electret substrate 133 is transmitted to the hand shaft 82 via the wheel train to move the second hand 17 on the dial 14.

FIG. 16 and FIG. 17 show an example in which the first counter electrode 134 and the second counter electrode 135 are arranged in a fixed manner so as to have different phases in the moving direction of the electret substrate 133, but as illustrated in FIG. 15, the first counter electrode 134 and the second counter electrode 135 may be arranged in a fixed manner so as to have the same phase in the moving direction of the electret substrate 133.

The circuit configuration for using the electrostatic induction-type converter as the electric generator or the electric motor described above is merely an example, and other configurations including the arrangement of various members may be adopted.

In the seventh embodiment, description is given of an example in which the electret films are provided on both surfaces of the conductive substrate 331, but the present invention is not limited thereto. The electret film may be provided only on one surface of the conductive substrate 331. In this case, the counter electrode to be opposed to the electret film may be arranged only on the side on which the electret film is provided.

Further, in the seventh embodiment, as illustrated in FIG. 14, description is given of an example in which the moisture absorbent sheet 50 and the holding sheet 60 described in the first embodiment are used, but the present invention is not limited thereto. That is, there may be employed a configuration in which the wristwatch 1 using each moisture absorbent sheet and each holding sheet described in the second to sixth embodiments includes the built-in electrostatic induction-type converter.

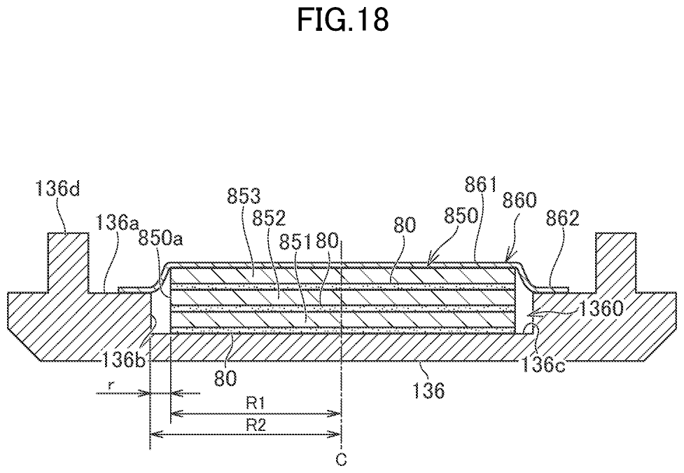

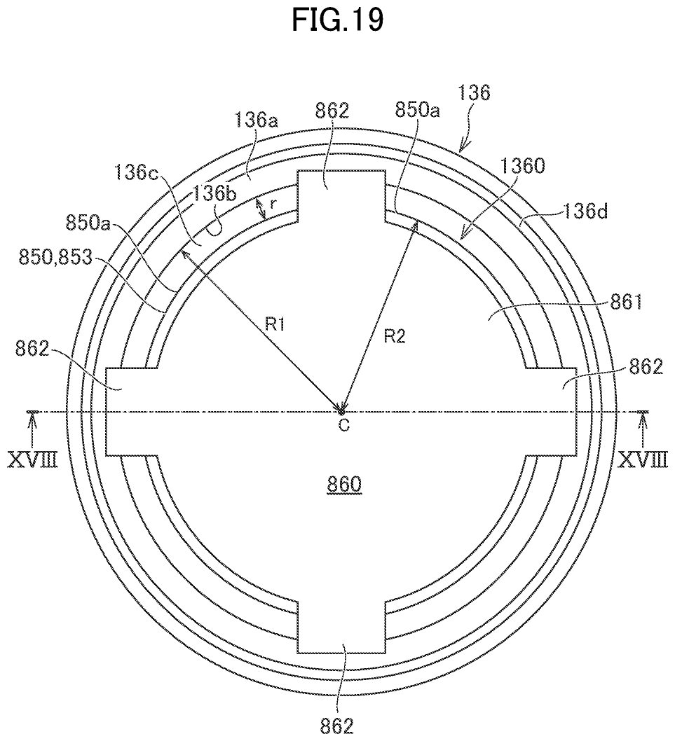

Further, with reference to FIG. 18 and FIG. 19, an eighth embodiment of the present invention is described. FIG. 18 is a sectional view for illustrating a configuration for holding a moisture absorbent sheet in the eighth embodiment. Further, FIG. 18 shows a cross section taken along the line XVIII-XVIII of FIG. 19. FIG. 19 is a plan view for illustrating the configuration for holding the moisture absorbent sheet in the eighth embodiment.

As illustrated in FIG. 18, in the eighth embodiment, description is given of an example in which the wristwatch 1 includes a plurality of laminated moisture absorbent sheets. Specifically, description is given of an example in which a moisture absorbent sheet laminate 850 is provided on a back cover 136.

The moisture absorbent sheet laminate 850 includes a first moisture absorbent sheet 851, a second moisture absorbent sheet 852, and a third moisture absorbent sheet 853. The first moisture absorbent sheet 851 and the second moisture absorbent sheet 852 are bonded to each other by a double-sided adhesive sheet 80. Similarly, the second moisture absorbent sheet 852 and the third moisture absorbent sheet 853 are bonded to each other by a double-sided adhesive sheet 80. Further, the first moisture absorbent sheet 851 is bonded to the back cover 136 by a double-sided adhesive sheet 80.

In the eighth embodiment, the moisture absorbent sheet laminate 850 including a plurality of moisture absorbent sheets is provided. In this manner, the moisture absorbing performance can be improved, and a further appropriate humidity can be kept inside the wristwatch 1.

In this case, the moisture absorbent sheet laminate 850 is formed by bonding three moisture absorbent sheets, and hence the thickness as a whole is larger than the moisture absorbent sheet 50 described in the first embodiment, for example. Therefore, the moisture absorbent sheets may interfere with the movement 38 (see FIG. 2).

In view of the above, in the eighth embodiment, a recessed portion 1360 is formed in the back cover 136. With the recessed portion 1360 being formed, the back cover 136 has a bottom surface 136c recessed with respect to an inner surface 136a, and a rising surface 136b rising from the bottom surface 136c. Further, the moisture absorbent sheet laminate 850 is provided on the bottom surface 136c. That is, the first moisture absorbent sheet 851 being the lowermost layer of the moisture absorbent sheet laminate 850 is bonded to the bottom surface 136c by the double-sided adhesive sheet 80.

In the eighth embodiment, similarly to the back cover 36 described in the first embodiment, the back cover 136 may be, for example, a so-called snap back-type back cover. The back cover 136 has, as illustrated in FIG. 18 and FIG. 19, an annular wall portion 136d rising from the inner surface 136a. The body 35 may be fitted on an inner side of the wall portion 136d so that the back cover 136 is fixed with respect to the body 35. Further, the recessed portion 1360 is formed on the inner side of the wall portion 136d.

Further, in the eighth embodiment, there is adopted a configuration in which the moisture absorbent sheet laminate 850 is held by a holding sheet 860. As illustrated in FIG. 18 and FIG. 19, the holding sheet 860 is provided so as to cover the moisture absorbent sheet laminate 850.

The holding sheet 860 may be an adhesive sheet having an adhesive layer on its lower surface. The holding sheet 860 includes a circular portion 861 and projecting portions 862. The circular portion 861 has a substantially circular shape in plan view. The projecting portions 862 project radially outward from the circular portion 861. The circular portion 861 is provided so as to cover a part of the third moisture absorbent sheet 853 being the uppermost layer of the moisture absorbent sheet laminate 850. Further, the projecting portions 862 are provided so as to adhere to the inner surface 136a of the back cover 136. As described above, the moisture absorbent sheet laminate 850 is held on the bottom surface 136c of the back cover 136 by the holding sheet 860.

Further, in the eighth embodiment, the moisture absorbent sheet laminate 850 is provided on the bottom surface 136c so as to have a gap between its side surface 850a and the rising surface 136b. That is, the recessed portion 1360 is formed in the back cover 136 so that a radius R1 of the recessed portion 1360 of the back cover 136 in plan view is larger than a radius R2 of the moisture absorbent sheet laminate 850 in plan view. FIG. 18 and FIG. 19 show an example in which a gap having a width r is formed in the radial direction.

When the gap is formed as described above, the moisture absorbent sheets included in the moisture absorbent sheet laminate 850 are allowed to expand in the radial direction. Therefore, even when the moisture absorbent sheets included in the moisture absorbent sheet laminate 850 expand, the moisture absorbent sheet laminate 850 is less liable to peel off from the bottom surface 136c.

Further, in the eighth embodiment, as illustrated in FIG. 19, the holding sheet 860 is provided so that parts of the moisture absorbent sheet laminate 850 are exposed between the projecting portions 862 in the circumferential direction. With such a configuration, the moisture absorbent sheet laminate 850 can easily absorb water not only from the upper surface but also from the side surface 850a. That is, water can be absorbed not only by the third moisture absorbent sheet 853 but also by the first moisture absorbent sheet 851 and the second moisture absorbent sheet 852, and hence the moisture absorbing performance is further improved. As a result, a further appropriate humidity can be kept inside the wristwatch 1.

FIG. 19 shows an example in which the annular gap having the width r is formed, but the present invention is not limited thereto. The gap may be formed in a part in the circumferential direction.

Further, the shape of the holding sheet 860 is not limited to that illustrated in FIG. 19. The holding sheet 860 may cover substantially the entire moisture absorbent sheet laminate 850 in plan view, and have a moisture absorbing hole for partially exposing the moisture absorbent sheet laminate 850. Further, FIG. 19 shows an example in which the holding sheet 860 has four projecting portions 862, but the number of the projecting portions 862 is not limited thereto. Further, the holding sheet 860 may not have the projecting portion 862, and an edge portion of the circular portion 861 may be bonded to the inner surface 136a of the back cover 136.

Further, the holding sheet 860 is preferred to be formed of a member having stretchability. For example, the holding sheet 860 may be a resin sheet having stretchability. When the moisture absorbent sheet laminate 850 expands in a direction of pushing up the holding sheet 860, the holding sheet 860 may peel off from the inner surface 136a of the back cover 136. Through use of the holding sheet 860 having stretchability, the holding sheet 860 stretches along with the expansion of the moisture absorbent sheet laminate 850. In this manner, the holding sheet 860 is less liable to peel off from the inner surface 136a of the back cover 136.

Further, in the eighth embodiment, description is given of an example in which the moisture absorbent sheet laminate 850 includes three moisture absorbent sheets, but the number of the moisture absorbent sheets is not limited thereto. Further, the configuration in which the back cover 136 has the recessed portion 1360 may be applied to a case in which one moisture absorbent sheet is provided as in the first embodiment, for example. In this manner, a moisture absorbent sheet having a large thickness (that is, a large volume) and a large moisture absorbing amount can be used.

FIG. 18 shows a state in which each moisture absorbent sheet included in the moisture absorbent sheet laminate 850 has absorbed water to expand. When the moisture absorbent sheet laminate 850 is in a state of not absorbing water, for example, in a new state, a height of an upper surface of the third moisture absorbent sheet 853 being the uppermost layer may be lower than a height of the inner surface 136a of the back cover 136. That is, when the moisture absorbent sheet laminate 850 is in the state of not absorbing water, the thickness thereof may be smaller than a depth of the recessed portion 1360.

Further, the holding sheet 860 may be formed into a concave shape when the moisture absorbent sheet laminate 850 is in the state of not absorbing water so that at least a part of the holding sheet 860 is present at a position lower than the height of the inner surface 136a of the back cover 136. Further, the holding sheet 860 may be formed into a convex shape when the moisture absorbent sheet laminate 850 is in the state of absorbing water to expand (in the state illustrated in FIG. 18) so that at least a part of the holding sheet 860 is present at a position higher than the height of the inner surface 136a of the back cover 136. Further, the maximum value of a curvature radius of the holding sheet 860 when the moisture absorbent sheet laminate 850 is in the state of absorbing water to expand may be smaller than the maximum value of a curvature radius of the holding sheet 60 when the moisture absorbent sheet 50 is in the state of absorbing water to expand in the first embodiment. As described above, when the recessed portion 1360 is formed such that the maximum value of the curvature radius of the holding sheet 860 is decreased, the peeling-off of the holding sheet 860 from the inner surface 136a can be suppressed.

In the embodiments described above, the holding sheet may have moisture permeability. In this manner, the moisture absorbent sheet may more easily absorb moisture even in the part covered with the holding sheet. When the holding sheet has moisture permeability, the holding sheet may be formed into a shape covering not only the edge of the moisture absorbent sheet but the entire surface of the moisture absorbent sheet. In any case, the holding sheet may hold the moisture absorbent sheet such that the moisture absorbent sheet can absorb moisture.

In the embodiments described above, the planar shapes of the moisture absorbent sheet and the holding sheet are substantially circular shapes, but the present invention is not limited thereto. For example, when the planar shape of the inner surface of the back cover is a rectangular shape, a moisture absorbent sheet and a holding sheet each having a planar shape formed into a rectangular shape may be adopted in accordance therewith.

In the embodiments described above, the wristwatch 1 is described, but the present invention is not limited thereto. The present invention is only required to be a small-sized mobile device such as an illuminating device or various sensors. Even in a mobile device other than the wristwatch 1, when the configuration described in each of the embodiments above is applied thereto, the peeling-off of the moisture absorbent sheet can be suppressed, and a moderate humidity can be kept inside the device.

In the embodiments described above, description is given of an example in which the conduction is established between the movement 38 being the motive power mechanism and the back cover 36 via the earth spring 70, but the present invention is not limited thereto. The conduction may be established between the movement 38 and the body 35 made of a metal via the earth spring. In this case, the earth spring serving as the conducting member may be arranged to extend from a side surface of the movement 38 toward the body 35.

In the above, the embodiments according to the present invention are described. However, the specific configurations described in the embodiments are described as examples, and are not intended to limit the technical scope of the present invention to those embodiments. Various modifications may be made by a person skilled in the art to those disclosed embodiments. It is to be understood that the technical scope of the invention disclosed in the present application cover all such modifications.

The invention claimed is:

1. A mobile device, comprising:
an exterior case including a back cover;
a moisture absorbent sheet provided on an inner surface of the back cover; and
a holding sheet configured to at least adhere to the inner surface of the back cover around the moisture absorbent sheet and cover an edge of the moisture absorbent sheet, to thereby hold the moisture absorbent sheet such that the moisture absorbent sheet is allowed to absorb moisture.

2. The mobile device according to claim 1, further comprising a motive power mechanism located in the exterior case,
wherein the back cover has conductivity,
wherein the holding sheet has conductivity, and
wherein the motive power mechanism and the back cover are conducted via a conducting member extending from the motive power mechanism in contact with the holding sheet.

3. The mobile device according to claim 1, further comprising a motive power mechanism located in the exterior case,
wherein the back cover has conductivity,
wherein the holding sheet has a cutout or a hole for exposing a part of the inner surface of the back cover, and
wherein the motive power mechanism and the back cover are conducted via a conductive member extending from the motive power mechanism to be in contact with a region of the inner surface of the back cover, which is exposed from the cutout or the hole.

4. The mobile device according to claim 3, wherein the moisture absorbent sheet has a cutout shaped to conform to the cutout of the holding sheet, or a hole shaped to conform to the hole of the holding sheet.

5. The mobile device according to claim 1, wherein the holding sheet has a planar shape formed into a ring shape for exposing the moisture absorbent sheet at a center portion thereof.

6. The mobile device according to claim 1, wherein the holding sheet has a plurality of moisture absorbing holes for partially exposing the moisture absorbent sheet.

7. The mobile device according to claim 1, wherein the holding sheet has moisture permeability.

8. The mobile device according to claim 1, further comprising a double-sided adhesive member configured to cause a lower surface of the moisture absorbent sheet to adhere to the inner surface of the back cover.

9. The mobile device according to claim 1, wherein the moisture absorbent sheet contains calcium oxide.

10. The mobile device according to claim 1, further comprising a piezoelectric element to be provided on the inner surface of the back cover,
wherein the moisture absorbent sheet has a planar shape formed into a ring shape surrounding the piezoelectric element.

11. The mobile device according to claim 1,
wherein the exterior case includes a body, and
wherein any one of the back cover and the body includes a locking portion, and another one of the back cover and the body includes a locked portion to be locked to the locking portion.

12. The mobile device according to claim 2,
wherein the exterior case includes a body, and
wherein any one of the back cover and the body has a female thread formed in an inner peripheral surface thereof, and another one of the back cover and the body has a male thread formed in an outer peripheral surface thereof to engage with the female thread.

13. The mobile device according to claim 1, further comprising an electrostatic induction-type converter including:
a conductive substrate;
an electret film, which is to be formed on a surface of the conductive substrate, and which is charged; and
a counter electrode to be arranged so as to be opposed to the electret film,
wherein the conductive substrate is to be provided so as to be relatively movable with respect to the counter electrode.

14. The mobile device according to claim 1, wherein the moisture absorbent sheet includes a plurality of laminated moisture absorbent sheets.

15. The mobile device according to claim 1,
wherein the back cover has a recessed portion in the inner surface, and
wherein the moisture absorbent sheet is provided on a bottom surface of the recessed portion.

16. The mobile device according to claim 15, wherein the moisture absorbent sheet is provided so as to have a gap between the moisture absorbent sheet and a rising surface of the recessed portion.
